(19) United States
(12) Patent Application Publication
(10) Pub. No.: US 2019/0009348 A1
(43) Pub. Date: Jan. 10, 2019

(54) DEBURRING TOOL

(71) Applicant: Cogsdill Tool Products, Inc., Lugoff, SC (US)

(72) Inventor: William A. Robinson, South Lyon, MI (US)

(21) Appl. No.: 16/026,623

(22) Filed: Jul. 3, 2018

Related U.S. Application Data
(60) Provisional application No. 62/529,641, filed on Jul. 7, 2017.

(51) Int. Cl. B23B 51/10; B23B 41/00; B23B 51/08; B23B 51/04

(52) U.S. Cl. CPC B23B 51/101; B23B 41/006; B23B 51/08; B23B 2220/08; B23B 2200/0471; B23B 2205/04; B23B 2215/32; B23B 51/048

(57) ABSTRACT

A deburring tool that includes a deburring arm which is held in a flexible relationship with respect to an arbor of the deburring tool. In some implementations, the deburring tool is capable of drilling a hole, deburring the hole with the deburring arm, and machining one or more features in the hole, such as an end chamfer. A plurality of attachment elements are located in the arbor to engage the deburring arm. The deburring tool may also include a second deburring arm that is particularly oriented with respect to one or more cutting elements used for drilling the hole.

### CROSS-REFERENCE TO RELATED APPLICATION

This application claims the benefit of U.S. Provisional Application Ser. No. 62/529,641 filed on Jul. 7, 2017, the entire contents of which are incorporated herein by reference.

### FIELD

This invention generally relates to rotary tools, and more particularly, to deburring and drilling tools used with metal workpieces.

### BACKGROUND

With certain deburring and/or drilling operations, separate tools may need to be used to obtain desired results, such as a drilled hole without burrs and with particular chamfers or other formed or engraved features. In some instances, a primary operation is used to drill a hole in a metal workpiece, and a secondary operation is then conducted to deburr the drilled hole, for example. If the process is done by hand, it may not be consistent, and it is possible for an operator to grind the chamfer or other formed feature such that it is too small or too large. Challenges may be amplified in certain applications, such as drilling and/or deburring holes that are formed in laid railroad tracks. When joining two pieces of track, the joint must be attached by bolting on a plate. If the holes are not properly prepped, it is possible that the holes will not line up properly, thereby making insertion of the bolts difficult.

### SUMMARY

In accordance with one embodiment, there is provided a deburring tool comprising an arbor having a rearward end, a forward end, and an elongated slot generally extending in an axial direction of the arbor; a deburring arm attached in the elongated slot of the arbor and having an attachment end and a deburring end; and a plurality of attachment elements including first and second attachment elements, the first attachment element is located at a first axial position along the arbor and the second attachment element is located at a second axial position along the arbor that is closer to the forward end than the first axial position. The first attachment element engages the attachment end of the deburring arm and the second attachment element maintains the deburring arm in the elongated slot so that the deburring arm is configured to flex between a radially extended deburring position and a radially retracted non-deburring position during use of the deburring arm.

In accordance with another embodiment, there is provided a deburring tool comprising an arbor having a rearward end, a forward end, and first and second elongated slots generally extending in an axial direction of the arbor; first and second deburring arms attached in the first and second elongated slots of the arbor, each of the first and second deburring arms having an attachment end and a deburring end; and first and second cutting elements attached at the forward end of the arbor, the first and second cutting elements are arranged as a drill bit for creating a bore. The first deburring arm is attached in the first elongated slot at a first circumferential position on the arbor and the second deburring arm is attached in the second elongated slot at a second circumferential position on the arbor that is diametrically offset with respect to the first circumferential position.

### DRAWINGS

Embodiments of the invention will hereinafter be described in conjunction with the appended drawings, wherein like designations denote like elements, and wherein:

FIG. 1 is a drilling unit with a deburring tool in accordance with one embodiment;

FIG. 2 is an exploded perspective view of the deburring tool of FIG. 1;

FIG. 3 is a perspective view of the deburring tool of FIGS. 1 and 2;

FIG. 4 is a top view of the deburring tool of FIGS. 1-3;

FIG. 5 is a partially sectioned side view of the deburring tool of FIGS. 1-4 showing the configuration of some of the interior components of the deburring tool according to one embodiment; and

FIG. 6 is an end view of the deburring tool of FIGS. 1-5.

### DESCRIPTION

The deburring tool described herein is capable of drilling a hole, deburring the hole, and/or machining one or more features in the hole, such as an end chamfer. In some embodiments, the deburring tool can carry out each of these functions in a single operation. In a particular embodiment, the deburring tool may be used with, or as a part of, a railroad drilling unit. The deburring tool may include a deburring arm which is held in a flexible relationship with respect to an arbor of the deburring tool. One or more attachment elements may be used to flexibly hold the deburring arm with relation to the arbor.

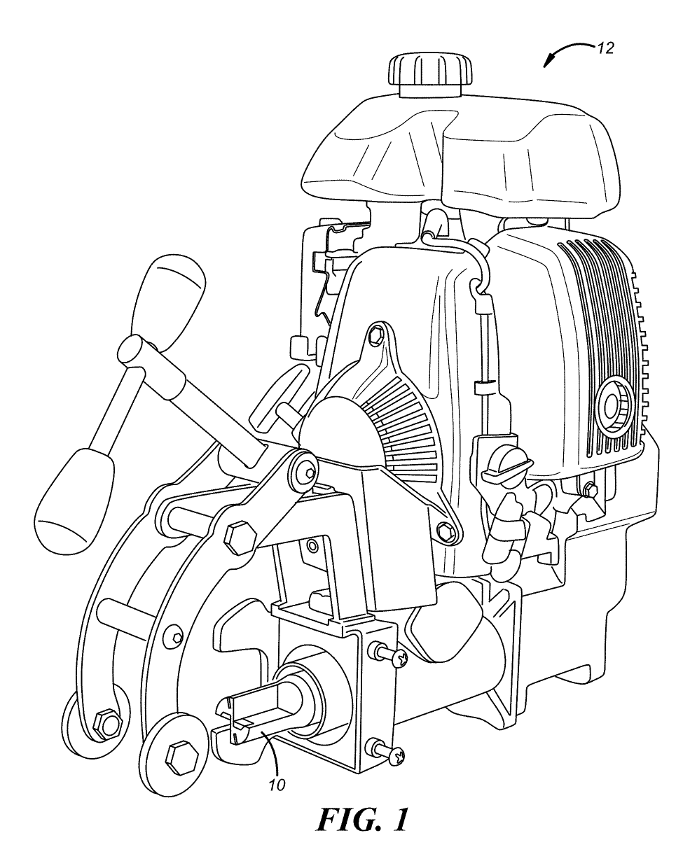

With reference to FIG. 1, there is schematically shown a deburring tool 10 installed within a chuck or other tool holding device of an associated drilling unit 12. In this embodiment, drilling unit 12 is a portable railroad drilling unit which is used to drill holes in laid railroad tracks. When joining two pieces of railroad track, the joint is typically attached by bolting the tracks on a plate. Effective preparation of the holes at each joint can help support the track properly. In some embodiments, the deburring tool 10 may be used to machine holes in steel rails that are approximately 0.75 inches to 2.0 inches thick. When drilling these holes, a burr may form at the back of the hole that, if not removed, can prohibit proper mating between the track and plate. The deburring tool 10 can machine this burr from the hole during the drilling process.

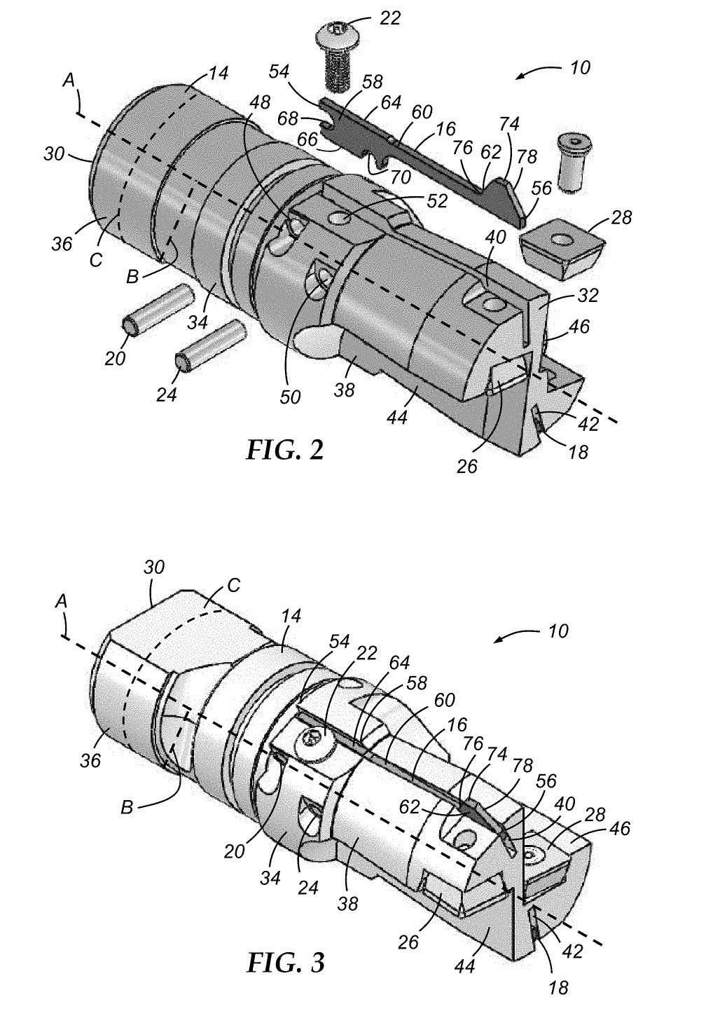

FIGS. 2-6 show different views of an example of the deburring tool 10. Deburring tool 10 may come in many embodiments, including those with more, less, or different components than the examples shown and described below. According to one embodiment, deburring tool 10 includes an arbor 14; one or more deburring arms 16, 18; one or more attachment elements 20, 22, 24; and one or more cutting elements 26, 28. Deburring tool 10 has a generally cylindrical shape which naturally defines a longitudinal axis A, a radius B (radius B can extend in any direction that is generally perpendicular to axis A and does not have to be the exemplary radius shown here), and a circumference C. In this regard, the term “axially” describes a direction that generally corresponds to longitudinal axis A, the term “radially” describes a direction that generally corresponds to radius B, and the term “circumferentially” describes a direction that generally corresponds to circumference C. These terms are simply used for illustrative purposes and can also apply to deburring tools having other non-cylindrical shapes.

With reference to FIGS. 2 and 3 in particular, arbor 14 carries the various deburring tool components and provides a means for securing the deburring tool into a chuck or spindle of a machine, such as drilling unit 12 shown in FIG. 1. According to one embodiment, arbor 14 is a generally cylindrical piece made of a standard tool steel (e.g., tool steel that has been hardened, coated, etc.) that extends from a rearward end 30 to a forward end 32 and generally includes a body 34 with a shank portion 36 and a working portion 38. The shank portion 36 is located toward the rearward end 30 and may have one or more ribs, grooves, flat segments, or other features to help facilitate attachment to or connection with a drilling unit. The working portion 38 is located toward the forward end 32 and can be inserted in and out of the metal workpiece when in use. The working portion 38 generally includes one or more elongated slots 40, 42 which may house the deburring arms 16, 18; flutes 44, 46 which may provide an area for removal of chips or other debris that may form during the drilling or deburring process; and bores 48, 50, 52 for accommodating attachment elements 20, 22, 24. The elongated slots 40, 42 are generally aligned in a direction parallel to longitudinal axis A, whereas the bores 48, 50, 52 are generally aligned in a direction perpendicular to the direction of the elongated slots. As will be detailed below, the working portion 38 can include another set of bores and associated attachment elements, which are not shown in FIGS. 2 and 3, to help hold and/or position the second deburring arm 18.

Deburring arms 16, 18 are coupled, indirectly or directly, to arbor 14 and are designed to clean the opening of a hole formed in the metal workpiece while forming a chamfer, radius, or some other feature. While the illustrated embodiment depicts a first and second deburring arm, more or less deburring arms are certainly possible depending on the desired implementation. Example features of the deburring arms are shown in FIG. 2 with respect to deburring arm 16. In one embodiment, the deburring arm 16 may be a one-piece structure made from high speed steel (e.g., M2 high speed steel) that extends from an attachment end 54 to a deburring end 56. The deburring arm 16 may include a retaining portion 58, a flexible arm portion 60, and a cutting portion 62. The retaining portion 58 may include a radially outboard surface 64 and a radially inboard surface 66. The retaining portion 58 may further include a pivot notch 68 generally situated at the attachment end 54 and a position notch 70 generally situated on the radially inboard surface 66. As will be detailed further below, the notches 68, 70 may be sized or shaped to accommodate one or more attachment elements. The flexible arm portion 60 extends from the retaining portion 58 and has a reduced height as compared to the retaining portion, which can permit the flexible arm portion to more easily bend so that the cutting portion 62 can move radially in and out of the elongated slot 40 during use. The cutting portion 62 may include a top side 74, a first sloped side 76, and a second sloped side 78; however other shaped or structured cutting portions are certainly possible. With reference to the side view illustrated in FIG. 5, the cutting portion 62 can cut, machine, and/or deburr the hole in the workpiece as the deburring arm 16 flexes between a radially retracted position 80 and a radially extended deburring position 82.

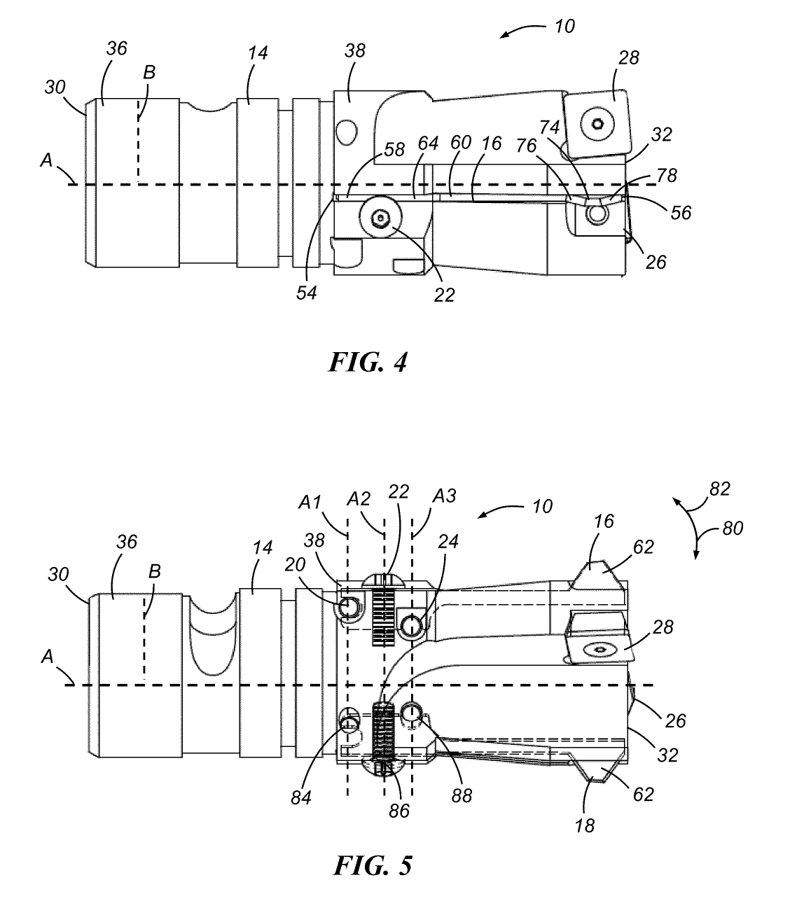

A plurality of attachment elements 20, 22, 24 are used to secure and/or position the deburring arm 16 with respect to the arbor 14. According to one embodiment, a first attachment element in the form of a dowel pin 20 is used to help position the deburring arm 16 at its pivot notch 68, and a second attachment element in the form of a screw 22 is used to help retain the deburring arm 16 so that the radially outboard surface 64 is limited in the extent to which it can travel beyond the elongated slot 40. As best seen in FIGS. 4 and 5, the head of the screw 22 may at least partially block or obstruct the elongated slot 40 shown in FIG. 4 along the outer circumference C of the arbor 14. Accordingly, during operation, the radially outboard surface 64 of the retaining portion 58 of the deburring arm 16 may contact a bottom or under surface of the head of the button screw 22. Thus, it is preferable for the second attachment element 22 to at least partially extend beyond the outer diameter of the arbor 14 to allow a greater range of motion of the deburring arm 16 within the elongated slot 40. Further, it may be helpful to have the second attachment element 22 be removable in order to facilitate replacement of the deburring arm 16. For example, when used with railroad drilling operations, it may be necessary to replace the deburring arm 16 more frequently due to the strength and thickness of the workpieces. To replace the deburring arm 16, the screw 22 can be removed, a new deburring arm 16 can be installed, and the screw 22 or a new second attachment element can be installed in the bore 52. In one embodiment, the deburring tool 10 also includes a third attachment element in the form of a second dowel pin 24 which may be used as a pivot point or fulcrum and can help position the deburring arm 16 at its position notch 70. The dowel pins 20, 24 may be permanently or semi-permanently installed in the arbor 14 with adhesive or with a press-fit installation. While the attachment elements 20, 22, 24 are shown as dowel pins and a screw, it is possible to use other forms of attachment elements such as bolts, brackets, or any other operable fastener.

The relative positioning of the attachment elements 20, 22, 24 is illustrated in the side view of the deburring tool 10 in FIG. 5. In this embodiment, the first attachment element 20 is located at a first axial position A₁, second attachment element 22 is located at a second axial position A₂ that is closer to the forward end 32 than the first axial position A₁. The third attachment element 24 is located at a third axial position A₃ along the arbor 14 that is closer to the forward end 32 than the second axial position A₂. According to this particular embodiment, the second attachment element 22 is generally in-line with the radius B (i.e., it extends in a radial direction) and the first and third attachment elements 20, 24 are generally oriented such that they are orthogonal to the second attachment element 22 and/or the radius B. It should be understood, however, that other orientations are possible besides those illustrated. For example, it may be possible to switch the positioning of the second and third attachment elements such that the second attachment element 22 is located closer to the forward end 32 than the third attachment element 24. In order to promote consistency in terms of the size and shape of the chamfers formed during deburring, attachment elements 20, 24 may be permanently installed and attachment element 22 may be designed to always thread into hole 52 to the same depth so that deburring arm 16 consistently protrudes out of the arbor 14 by the same distance (e.g., 0.002 inches to 0.010 inches). Other configurational adjustments are certainly possible.

FIG. 5 also shows a second set of attachment elements 84, 86, 88 which are used to secure and/or position the second deburring arm 18. In this embodiment, the first attachment element 84 for the deburring arm 18 is in the same axial position A₁ as the first attachment element 20, the second attachment element 86 for the deburring arm 18 is in the same axial position A₂ as the second attachment element 22, and the third attachment element 88 for the deburring arm 18 is in the same axial position A₃ as the third attachment element 24.

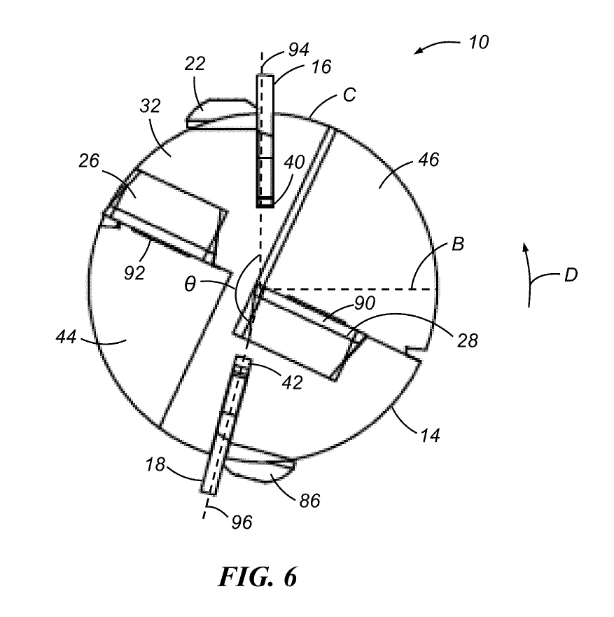

FIG. 6 illustrates an end view of the deburring tool 10 at the forward end 32 showing the cutting elements 26, 28. The cutting elements 26, 28 may be screwed in or otherwise attached at the forward end 32 of the arbor 14 and may be arranged as a drill bit for drilling or otherwise creating a bore. The cutting elements 26, 28 each have a cutting face 90, 92, which may be used to perform a majority of the workpiece drilling or machining. Accordingly, the cutting elements 26, 28, in some embodiments, may be made from carbide or another sufficiently strong material depending on the desired implementation. The cutting faces 90, 92 may be generally in-line with a wall of each flute 44, 46 and as the deburring tool 10 spins in the direction of rotation D, the cutting elements 26, 28, which extend slightly past the forward end 32 of the arbor 14, can machine a hole in the workpiece.

FIG. 6 also shows the various angular orientations of the deburring arms 16, 18 and cutting elements 26, 28 with respect to each other. In this embodiment, the cutting faces 92, 90 of the cutting elements 26, 28 are situated at an angle of about 180° with respect to each other, whereas the deburring arms 16, 18 are situated at an angle θ that is less than 180° with respect to the direction of rotation D. Accordingly, the first and second deburring arms 16, 18 and their associated elongated slots 40, 42 are located at first and second circumferential positions 94, 96 with respect to the arbor 14, with the first circumferential position 94 being diametrically offset with respect to the second circumferential position 96. Preferably, the angle θ between the deburring arms 16, 18 is less than or 180° with respect to the direction of rotation D because with angles greater than or equal to 180°, there may not be enough support along the sides of the deburring arms due to the cutting pressure. This may be changed and the angle θ may be 180° or greater, however, if the circumference of the arbor is larger given the same size fluting, deburring arms, cutting elements, etc. Also, with an angle θ of less than 180°, there is more room or clearance for the attachment elements 22, 86, which have a similar angular offset to the angular offset of the deburring arms. According to a non-limiting example, the deburring arms 16, 18 are separated in the direction of rotation by an angle θ that is between about 150° and 180°, inclusive.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A deburring tool, comprising:
an arbor having a rearward end, a forward end, and an elongated slot generally extending in an axial direction of the arbor;
a deburring arm attached in the elongated slot of the arbor and having an attachment end and a deburring end; and
a plurality of attachment elements including first and second attachment elements, the first attachment element is located at a first axial position along the arbor and the second attachment element is located at a second axial position along the arbor that is closer to the forward end than the first axial position;
wherein the first attachment element engages the attachment end of the deburring arm and the second attachment element maintains the deburring arm in the elongated slot so that the deburring arm is configured to flex between a radially extended deburring position and a radially retracted non-deburring position during use of the deburring arm.

2. The deburring tool of claim 1, wherein the deburring arm includes a retaining portion, a flexible arm portion, and a cutting portion, wherein the flexible arm portion is located between the retaining portion and the cutting portion.

3. The deburring tool of claim 2, wherein the flexible arm portion has a reduced height compared to the retaining portion.

4. The deburring tool of claim 2, wherein the retaining portion includes a pivot notch at an attachment end that accommodates the first attachment element.

5. The deburring tool of claim 2, wherein the retaining portion includes a position notch situated on a radially inboard surface that accommodates a third attachment element.

6. The deburring tool of claim 1, further comprising a second deburring arm and a second set of first and second attachment elements that are used to engage the second deburring arm.

7. The deburring tool of claim 6, wherein both first attachment elements are located at the first axial position and both second attachment elements are located at the second axial position.

8. The deburring tool of claim 1, wherein the plurality of attachment elements further includes a third attachment element, the third attachment element is located at a third axial position along the arbor that is closer to the forward end than the second axial position.

9. The deburring tool of claim 8, wherein the first and third attachment elements are dowel pins that are semi-permanently installed in the arbor with an adhesive.

10. The deburring tool of claim 1, wherein the second attachment element is sized and shaped to cover at least a portion of the elongated slot so that the attachment end of the deburring arm is prevented from falling out of the elongated slot.

11. The deburring tool of claim 10, wherein a head of the second attachment element at least partially obstructs the elongated slot along an outer circumference of the arbor.

12. The deburring tool of claim 10, wherein the second attachment element at least partially extends beyond an outer diameter of the arbor.

13. The deburring tool of claim 10, wherein the second attachment element is a removable screw.

14. The deburring tool of claim 1, wherein the first attachment element is oriented orthogonal to the second attachment element.

15. The deburring tool of claim 1, further comprising at least one cutting element that is attached at the forward end of the arbor and is arranged as a drill bit for creating a bore.

16. A deburring tool, comprising:
an arbor having a rearward end, a forward end, and first and second elongated slots generally extending in an axial direction of the arbor;
first and second deburring arms attached in the first and second elongated slots of the arbor, each of the first and second deburring arms having an attachment end and a deburring end; and
first and second cutting elements attached at the forward end of the arbor, the first and second cutting elements are arranged as a drill bit for creating a bore;
wherein the first deburring arm is attached in the first elongated slot at a first circumferential position on the arbor and the second deburring arm is attached in the second elongated slot at a second circumferential position on the arbor that is diametrically offset with respect to the first circumferential position.

17. The deburring tool of claim 16, wherein the first and second deburring arms are separated in a direction of rotation by an angle that is between 150°-180°, inclusive.

18. The deburring tool of claim 16, wherein a first set of first, second, and third attachment elements engage the first deburring arm and a second set of first, second, and third attachment elements engage the second deburring arm.

19. The deburring tool of claim 18, wherein both first attachment elements are located at a first axial position along the arbor, both second attachment elements are located at a second axial position along the arbor, and both third attachment elements are located at a third axial position along the arbor, wherein the second and third axial positions are closer to the forward end of the arbor than the first axial position.

20. The deburring tool of claim 16, wherein the first cutting element is aligned with a wall of a first flute in the arbor and the second cutting element is aligned with a wall of a second flute in the arbor.
